(19) United States
(12) Patent Application Publication
(10) Pub. No.: US 2010/0134637 A1
(43) Pub. Date: Jun. 3, 2010

(54) TAKEN PICTURE PROVIDING SYSTEM, PICTURE TAKING MANAGEMENT SERVER, PICTURE TAKING MANAGEMENT METHOD AND PICTURE TAKING MANAGEMENT PROGRAM

(75) Inventors: Shisei cho, Tsurugashima (JP); Katsumi Amano, Tsurugashima (JP); Yoshikazu Takeuchi, Tsurugashima-Shi (JP); Tsuyoshio Sakamoto, Tsurugashima (JP)

Correspondence Address: YOUNG & THOMPSON, 209 Madison Street, Suite 500, Alexandria, VA, 22314, US

(73) Assignee: PIONEER CORPORATION, TOKYO (JP)

(21) Appl. No.: 12/531,522

(22) PCT Filed: Mar. 19, 2007
(86) PCT No.: PCT/JP2007/055540

§ 371 Date: Jan. 19, 2010

(51) Int. Cl. H04N 5/225

(52) U.S. Cl. 348/207.11; 348/E05.024

(57) ABSTRACT

A photographing management server is provided with a photographing request information acquiring unit for acquiring photographing request information from a photographing request device, a photographing load information transmission request unit that transmits the photographing request information and requests the transmission of photographing load information including a load amount, a photographing load information acquiring unit for acquiring photographing load information, a photographing request subject determining unit for determining a photographing device requested to photograph in accordance with the photographing load information, a photographing request unit for requesting the photographing device determined by the photographing request determining unit to photograph, an image data acquiring unit for acquiring image data from the photographing device requested by the photographing request unit and an image data provision unit for providing image data to the photographing request device. The photographing management server transmits the photographing request information to each photographing device.

### TECHNICAL FIELD

The present invention relates to a method of providing a picture corresponding to a picture taking request sent from an apparatus which is not located at a picture taking place.

### BACKGROUND TECHNIQUE

Conventionally, there is known a picture distribution system which provides a picture corresponding to a picture taking request from an apparatus which is not located at the picture taking place (For example, see. Patent Reference-1). Specifically, when an apparatus requesting the picture taking notifies the picture taking request information to a server, the server searches for a picture taking apparatus which passes the picture taking requested position by using travel route information, retained by the server itself and related to the picture taking apparatus, and performs a picture taking request to the picture taking apparatus which passes the picture taking requested position.

Patent Reference-1: Japanese Patent Application Laid-open under No. 2003-317193

### DISCLOSURE OF INVENTION

### Problem to be Solved by the Invention

However, by the above-mentioned picture distribution system, it is necessary for the server to retain the travel route information of each picture taking apparatus in a newest state, so as to determine the picture taking apparatus to which the picture taking is requested. Therefore, there occurs the following problem. Namely, every time when each picture taking apparatus changes the travel route information, each picture taking apparatus needs to notify the changed travel route to the server, regardless of whether there is a picture taking request or not. Thus, the communication burden between the server and each picture taking apparatus increases.

The above is one example of the problems to be solved by the present invention. It is an object of the present invention to provide a taken picture providing system capable of reducing the communication burden between the server and the picture taking apparatus and providing picture data corresponding to the picture taking request.

### Means for Solving the Problem

According to the invention of claim 1, a picture taking management server comprises: a picture taking request information obtaining means which obtains picture taking request information from a picture taking requesting apparatus; a picture taking burden information transmission requesting means which transmits the picture taking request information and performs transmission request of picture taking burden information including burden amount to each of picture taking apparatuses; a picture taking burden information obtaining means which obtains the picture taking burden information; a picture taking request object determining means which determines the picture taking apparatus, to which picture taking is requested, based on the picture taking burden information; a picture taking requesting means which requests picture taking to the picture taking apparatus determined by the picture taking request object determining means; a picture data obtaining means which obtains picture data from the picture taking apparatus to which the picture taking is requested by the picture taking requesting means; and a picture data providing means which provides the picture data to the picture taking requesting apparatus.

According to the invention of claim 4, a picture taking management method comprises: a picture taking request information obtaining process which obtains picture taking request information from a picture taking requesting apparatus; a picture taking burden information transmission requesting process which transmits the picture taking request information and performs transmission request of picture taking burden information including burden amount to each of picture taking apparatuses; a picture taking burden information obtaining process which obtains the picture taking burden information; a picture taking request object determining process which determines the picture taking apparatus, to which picture taking is requested, based on the picture taking burden information; a picture taking requesting process which requests picture taking to the picture taking apparatus determined by the picture taking request object determining process; a picture data obtaining process which obtains picture data from the picture taking apparatus to which the picture taking is requested by the picture taking requesting process; and a picture data providing process which provides the picture data to the picture taking requesting apparatus.

According to the invention of claim 5, a picture taking management program executed by an apparatus includes a computer, and the program makes the computer function as: a picture taking request information obtaining means which obtains picture taking request information from a picture taking requesting apparatus; a picture taking burden information transmission requesting means which transmits the picture taking request information and performs transmission request of picture taking burden information including burden amount to each of picture taking apparatuses; a picture taking burden information obtaining means which obtains the picture taking burden information; a picture taking request object determining means which determines the picture taking apparatus, to which picture taking is requested, based on the picture taking burden information; a picture taking requesting unit which requests picture taking to the picture taking apparatus determined by the picture taking request object determining means; a picture data obtaining unit which obtains picture data from the picture taking apparatus to which the picture taking is requested by the picture taking requesting means; and a picture data providing means which provides the picture data to the picture taking requesting apparatus.

According to the invention of claim 7, a picture taking apparatus comprises: a map information storing means which stores map information; a picture taking request information obtaining means which obtains picture taking request information including picture taking position information from a picture taking management server; a picture taking position route information generating means which generates, by using the map information, picture taking position route information which is information associated with a route including the picture taking position, when receiving the picture taking request information; a picture taking burden information generating means which generates picture taking burden information including burden amount associated with the picture taking position route information; a picture taking burden information providing means which provides the picture taking burden information to the picture taking management server; a picture taking request receiving means which receives picture taking request from the picture taking management server; a picture data generating means which generates picture data associated with the picture taking position information; and a picture data providing means which provides the picture data to the picture taking management server.

According to the invention of claim 10, a picture taking method comprises: a map information storing process which stores map information; a picture taking request information obtaining process which obtains picture taking request information including picture taking position information from a picture taking management server; a picture taking position route information generating process which generates, by using the map information, picture taking position route information which is information associated with a route including the picture taking position, when receiving the picture taking request information; a picture taking burden information generating process which generates picture taking burden information including burden amount associated with the picture taking position route information; a picture taking burden information providing process which provides the picture taking burden information to the picture taking management server; a picture taking request receiving process which receives picture taking request from the picture taking management server; a picture data generating process which generates picture data associated with the picture taking position information; and a picture data providing process which provides the picture data to the picture taking management server.

According to the invention of claim 11, a picture taking program executed by an apparatus includes a computer, and the program makes the computer function as: a map information storing means which stores map information; a picture taking request information obtaining means which obtains picture taking request information including picture taking position information from a picture taking management server; a picture taking position route information generating means which generates, by using the map information, picture taking position route information which is information associated with a route including the picture taking position, when receiving the picture taking request information; a picture taking burden information generating means which generates picture taking burden information including burden amount associated with the picture taking position route information; a picture taking burden information providing means which provides the picture taking burden information to the picture taking management server; a picture taking request receiving means which receives picture taking request from the picture taking management server; a picture data generating means which generates picture data associated with the picture taking position information; and a picture data providing means which provides the picture data to the picture taking management server.

According to the invention of claim 13, a taken picture providing system comprises a picture taking requesting apparatus, picture taking apparatuses and a picture taking management server, wherein the picture taking requesting apparatus comprises: a picture taking request information generating means which generates picture taking request information including a picture taking position; a picture taking request notifying means which transmits the picture taking request information and notifies picture taking request to the picture taking management server; and a picture data obtaining means which obtains picture data from the picture taking management server, wherein the picture taking management server comprises: a picture taking request information obtaining means which obtains picture taking request information from the picture taking requesting apparatus; a picture taking burden information transmission requesting means which transmits the picture taking request information and performs transmission request of picture taking burden information including burden amount to each of the picture taking apparatuses; a picture taking burden information obtaining means which obtains the picture taking burden information; a picture taking request object determining means which determines the picture taking apparatus, to which picture taking is requested, based on the picture taking burden information; a picture taking requesting means which requests picture taking to the picture taking apparatus determined by the picture taking request object determining means; a picture data obtaining means which obtains the picture data from the picture taking apparatus to which the picture taking is requested by the picture taking requesting means; and a picture data providing means which provides the picture data to the picture taking requesting apparatus, and wherein the picture taking apparatus comprises: a map information storing means which stores map information; a picture taking request information obtaining means which obtains picture taking request information including picture taking position information from the picture taking management server; a picture taking position route information generating means which generates, by using the map information, picture taking position route information which is information associated with a route including the picture taking position, when receiving the picture taking request information; a picture taking burden information generating means which generates picture taking burden information including burden amount associated with the picture taking position route information; a picture taking burden information providing means which provides the picture taking burden information to the picture taking management server; a picture taking request receiving means which receives picture taking request from the picture taking management server; a picture data generating means which generates picture data associated with the picture taking position information; and a picture data providing means which provides the picture data to the picture taking management server.

### BRIEF DESCRIPTION OF THE DRAWINGS

FIG. 1 is a diagram showing a schematic configuration of a taken picture providing system;

FIG. 2 is a conceptual diagram of a navigation apparatus;

FIG. 3 is a block diagram showing a schematic configuration of a picture taking requesting unit;

FIG. 4 is a schematic diagram showing data structure of picture taking request information;

FIG. 5 is a block diagram showing a schematic configuration of a picture taking management server;

FIG. 6 is a schematic diagram showing data structure of picture taking burden information;

FIG. 7 is a block diagram showing a schematic configuration of a picture taking unit;

FIG. 8 is a diagram showing an example of calculating burden amount;

FIG. 9 is a flowchart of picture taking requesting process;

FIG. 10 is a flowchart of picture taking management process; and

FIG. 11 is a flowchart of picture taking process.

### BRIEF DESCRIPTION OF REFERENCE NUMBERS

1 Taken picture providing system
200 Navigation apparatus
300 Picture taking requesting unit
400 Picture taking unit
500 Picture taking management server
754 Picture data
800 Picture taking request information
830 Picture taking burden information

### DETAILED DESCRIPTION OF THE PREFERRED EMBODIMENTS

According to one aspect of the present invention, there is provided a picture taking management server comprising: a picture taking request information obtaining means which obtains picture taking request information from a picture taking requesting apparatus; a picture taking burden information transmission requesting means which transmits the picture taking request information and performs transmission request of picture taking burden information including burden amount to each of picture taking apparatuses; a picture taking burden information obtaining means which obtains the picture taking burden information; a picture taking request object determining means which determines the picture taking apparatus, to which picture taking is requested, based on the picture taking burden information; a picture taking requesting means which requests picture taking to the picture taking apparatus determined by the picture taking request object determining means; a picture data obtaining means which obtains picture data from the picture taking apparatus to which the picture taking is requested by the picture taking requesting means; and a picture data providing means which provides the picture data to the picture taking requesting apparatus.

Specifically, the above picture taking management server may be formed as a server apparatus. The picture taking request information obtaining means obtains the picture taking request information from the picture taking requesting apparatus. Here, the picture taking request information includes information of the picture taking place where the picture taking requesting apparatus desires to take picture. The picture taking burden information transmission requesting means transmits the picture taking request information and performs the transmission request of the picture taking burden information. Here, the picture taking burden information includes the burden amount required when each of the picture taking apparatus goes to the picture taking place and takes picture.

The picture taking burden information obtaining means obtains the picture taking burden information from the picture taking apparatuses. Then, the picture taking request object determining means refers to the picture taking burden information, and determines the picture taking apparatus to which the picture taking request is performed. For example, the picture taking request object determining means determines that the picture taking request is performed to the picture taking apparatus whose burden amount is smallest. Then, the picture taking requesting means requests the picture taking to the picture taking apparatus determined by the picture taking request object determining means.

The picture data obtaining means obtains the picture data transmitted by the picture taking apparatus to which the picture taking request is performed. Then, the picture data providing means provides the picture data to the picture taking requesting apparatus.

As described above, by transmitting the picture taking request information obtained from the picture taking requesting apparatus to each of the picture taking apparatuses, the picture taking management server can obtain, from each of the picture taking apparatuses, the picture taking burden information including the burden amount of the picture taking apparatus based on the picture taking position information included in the picture taking request information, and can refer to the burden amount to determine the most appropriate picture taking apparatus for the picture taking. In addition, since the picture taking management server itself does not store the route information of each of the picture taking apparatuses, it is not necessary for each of the picture taking apparatuses to transmit the route change information to the picture taking management server according to the route change of each of the picture taking apparatuses. Therefore, the communication burden of the picture taking management server and the picture taking apparatuses can be reduced.

According to one feature of the picture taking management server, the picture taking burden information includes picture taking possible condition information, and the picture taking request object determining means eliminates the picture taking apparatus which transmitted the picture taking burden information including the burden amount inconsistent with the picture taking possible condition information. In this case, it can be avoided that the picture taking management server performs the picture taking request to the picture taking apparatus which is not in condition for taking picture.

According to another feature, the picture taking management server further comprises a picture retaking request control means which performs picture retaking request when receiving a picture taking canceling request. In this case, when the picture taking apparatus to which the picture taking management server performed the picture taking request becomes unable to take picture and the picture taking management server receives the picture taking canceling request from the picture taking apparatus, the picture taking management server can obtain the desired picture data of the picture taking requesting apparatus from other picture taking apparatus if the picture retaking request control means performs the picture retaking requesting process. Here, the picture retaking requesting process is to transmit the picture taking request information to the picture taking apparatuses other than the picture taking apparatus that has transmitted the canceling request, to perform the transmission request of the picture taking burden information, to determine the picture taking apparatus to which the picture taking request is performed based on the picture taking burden information received from each of the picture taking apparatuses, and to perform the picture taking request to the picture taking apparatus thus determined.

According to another aspect of the present invention, there is provided a picture taking management method comprising: a picture taking request information obtaining process which obtains picture taking request information from a picture taking requesting apparatus; a picture taking burden information transmission requesting process which transmits the picture taking request information and performs transmission request of picture taking burden information including burden amount to each of picture taking apparatuses; a picture taking burden information obtaining process which obtains the picture taking burden information; a picture taking request object determining process which determines the picture taking apparatus, to which picture taking is requested, based on the picture taking burden information; a picture taking requesting process which requests picture taking to the picture taking apparatus determined by the picture taking request object determining process; a picture data obtaining process which obtains picture data from the picture taking apparatus to which the picture taking is requested by the picture taking requesting process; and a picture data providing process which provides the picture data to the picture taking requesting apparatus.

Also in this method, by transmitting the picture taking request information obtained from the picture taking requesting apparatus to each of the picture taking apparatuses, it is possible to obtain, from each of the picture taking apparatuses, the picture taking burden information including the burden amount of each of the picture taking apparatuses based on the picture taking place information included in the picture taking request information, and it is also possible to determine the most appropriate picture taking apparatus for taking picture by referring to the burden amount.

According to still another aspect of the present invention, there is provided a picture taking management program executed by an apparatus including a computer, the program makes the computer function as: a picture taking request information obtaining means which obtains picture taking request information from a picture taking requesting apparatus; a picture taking burden information transmission requesting means which transmits the picture taking request information and performs transmission request of picture taking burden information including burden amount to each of picture taking apparatuses; a picture taking burden information obtaining means which obtains the picture taking burden information; a picture taking request object determining means which determines the picture taking apparatus, to which picture taking is requested, based on the picture taking burden information; a picture taking requesting unit which requests picture taking to the picture taking apparatus determined by the picture taking request object determining means; a picture data obtaining unit which obtains picture data from the picture taking apparatus to which the picture taking is requested by the picture taking requesting means; and a picture data providing means which provides the picture data to the picture taking requesting apparatus.

By executing the program on various kinds of apparatus, the picture taking management server according to the present invention can be realized. The picture taking management program can be preferably handled in a manner recorded on a storage medium.

According to still another aspect of the present invention, there is provided a picture taking apparatus comprising: a map information storing means which stores map information; a picture taking request information obtaining means which obtains picture taking request information including picture taking position information from a picture taking management server; a picture taking position route information generating means which generates, by using the map information, picture taking position route information which is information associated with a route including the picture taking position, when receiving the picture taking request information; a picture taking burden information generating means which generates picture taking burden information including burden amount associated with the picture taking position route information; a picture taking burden information providing means which provides the picture taking burden information to the picture taking management server; a picture taking request receiving means which receives picture taking request from the picture taking management server; a picture data generating means which generates picture data associated with the picture taking position information; and a picture data providing means which provides the picture data to the picture taking management server.

Specifically, the above picture taking apparatus can be formed as a part of a navigation apparatus. The picture taking apparatus stores map information. The picture taking request information obtaining means obtains the picture taking request information including the picture taking position information. The picture taking position route information generating means searches the map information for the route passing the picture taking position or the route whose destination is the picture taking position, and calculates the necessary time for traveling the route. Then, the picture taking position route information generating means generates the picture taking position route information including the route and the necessary time.

The picture taking burden information generating means generates the picture taking burden information including the burden amount in case of traveling along the route associated with the picture taking position. An example of the burden amount is the increased amount of the necessary time in case of traveling along the route associated with the picture taking position. Then, the picture taking burden information providing means provides the picture taking burden information to the picture taking management server.

When the picture taking request is made by the picture taking management server, the picture taking request receiving means receives the picture taking request and sets the picture taking position route information. Then, the picture data obtaining means generates the picture data taken at the picture taking position, and the picture data providing means provides the picture data to the picture taking management server.

As described above, the picture taking apparatus receives the picture taking request information including the picture taking position from the picture taking management server, searches the picture taking position passing route including the picture taking position, and transmits the picture taking burden information including the burden amount associated with the route. Therefore, since each of the picture taking apparatus calculates the burden amount, it becomes unnecessary for the picture taking management server to unifiedly store the route information of each of the picture taking apparatuses, and it becomes also unnecessary for the picture taking apparatus to notify the route change to the picture taking management server every time when the route of each of the picture taking apparatuses is changed. Therefore, the communication burden between the picture taking management server and each of the picture taking apparatuses can be reduced.

According to one feature of the picture taking apparatus, the picture taking burden information includes picture taking possible condition information. The picture taking possible condition is a condition in which the picture taking apparatus can take picture. For example, the upper limit value of the burden amount with which the picture taking is possible is set to the picture taking possible condition. In this case, the picture taking apparatus can include a condition with which the picture taking is possible to the picture taking burden information. Therefore, when the picture taking apparatus transmits the picture taking burden information including the picture taking possible information to the picture taking management server and the picture taking management server refers to the picture taking possible condition to determine the picture taking apparatus which takes picture, it can be avoided that the picture taking apparatus having the burden amount impossible to take picture receives the picture taking request from the picture taking management server.

According to another feature, the picture taking apparatus further comprises a picture taking request canceling means which cancels the picture taking request received by the picture taking request receiving means.

By this, the picture taking apparatus can cancel the picture taking request when it becomes unable to take picture after receiving the picture taking request from the picture taking management server.

According to still another aspect of the present invention, there is provided a picture taking method comprising: a map information storing process which stores map information; a picture taking request information obtaining process which obtains picture taking request information including picture taking position information from a picture taking management server; a picture taking position route information generating process which generates, by using the map information, picture taking position route information which is information associated with a route including the picture taking position, when receiving the picture taking request information; a picture taking burden information generating process which generates picture taking burden information including burden amount associated with the picture taking position route information; a picture taking burden information providing process which provides the picture taking burden information to the picture taking management server; a picture taking request receiving process which receives picture taking request from the picture taking management server; a picture data generating process which generates picture data associated with the picture taking position information; and a picture data providing process which provides the picture data to the picture taking management server.

Also by this method, since each of the picture taking apparatuses calculates the burden amount, the picture taking management server does not have to unifiedly store the route information of each of the picture taking apparatuses, and hence the picture taking apparatus does not have to notify the route change to the picture taking management server every time when the route of each of the picture taking apparatuses is changed. Therefore, the communication burden by the picture taking management server and each of the picture taking apparatuses can be reduced.

According to still another aspect of the present invention, there is provided a picture taking program executed by an apparatus including a computer, the program makes the computer function as: a map information storing means which stores map information; a picture taking request information obtaining means which obtains picture taking request information including picture taking position information from a picture taking management server; a picture taking position route information generating means which generates, by using the map information, picture taking position route information which is information associated with a route including the picture taking position, when receiving the picture taking request information; a picture taking burden information generating means which generates picture taking burden information including burden amount associated with the picture taking position route information; a picture taking burden information providing means which provides the picture taking burden information to the picture taking management server; a picture taking request receiving means which receives picture taking request from the picture taking management server; a picture data generating means which generates picture data associated with the picture taking position information; and a picture data providing means which provides the picture data to the picture taking management server.

By executing the program on a various kinds of apparatus, the picture taking apparatus of the invention can be realized. The picture taking program can be preferably handled in a state recorded on a storage medium.

According to still another aspect of the present invention, there is provided a taken picture providing system comprising a picture taking requesting apparatus, picture taking apparatuses and a picture taking management server, wherein the picture taking requesting apparatus comprises: a picture taking request information generating means which generates picture taking request information including a picture taking position; a picture taking request notifying means which transmits the picture taking request information and notifies picture taking request to the picture taking management server; and a picture data obtaining means which obtains picture data from the picture taking management server, wherein the picture taking management server comprises: a picture taking request information obtaining means which obtains picture taking request information from the picture taking requesting apparatus; a picture taking burden information transmission requesting means which transmits the picture taking request information and performs transmission request of picture taking burden information including burden amount to each of the picture taking apparatuses; a picture taking burden information obtaining means which obtains the picture taking burden information; a picture taking request object determining means which determines the picture taking apparatus, to which picture taking is requested, based on the picture taking burden information; a picture taking requesting means which requests picture taking to the picture taking apparatus determined by the picture taking request object determining means; a picture data obtaining means which obtains the picture data from the picture taking apparatus to which the picture taking is requested by the picture taking requesting means; and a picture data providing means which provides the picture data to the picture taking requesting apparatus, and wherein the picture taking apparatus comprises: a map information storing means which stores map information; a picture taking request information obtaining means which obtains picture taking request information including picture taking position information from the picture taking management server; a picture taking position route information generating means which generates, by using the map information, picture taking position route information which is information associated with a route including the picture taking position, when receiving the picture taking request information; a picture taking burden information generating means which generates picture taking burden information including burden amount associated with the picture taking position route information; a picture taking burden information providing means which provides the picture taking burden information to the picture taking management server; a picture taking request receiving means which receives picture taking request from the picture taking management server; a picture data generating means which generates picture data associated with the picture taking position information; and a picture data providing means which provides the picture data to the picture taking management server.

In the above system, after the picture taking requesting apparatus transmits the picture taking request information including the picture taking position information to the picture taking management server, the picture taking management server transmits the picture taking request information to each of the picture taking apparatuses. The picture taking apparatus searches the picture taking position route including the picture taking position, calculates the burden amount in case of traveling the picture taking position route, and transmits the picture taking burden information including the burden amount to the picture taking management server. The picture taking management server determines the picture taking apparatus performing the picture taking based on the burden amount of the picture taking burden information received from each of the picture taking apparatuses, and performs the picture taking request to the picture taking apparatus thus determined. The picture taking apparatus which receives the picture taking request takes picture at the place corresponding to the picture taking position information in the picture taking request information to generate picture data, and transmits the picture data to the picture taking management server. The picture taking management server transmits the picture data to the picture taking requesting apparatus.

As described above, the picture taking management server makes each of the picture taking apparatuses calculate the burden amount associated with the route including the picture taking position. Thereby, the picture taking management server does not have to unifiedly store the route information of each of the picture taking apparatuses, and hence the picture taking apparatus does not have to notify the route change to the picture taking management server every time when the route of each of the picture taking apparatuses is changed. Therefore, the communication burden of the picture taking management server and the picture taking apparatuses can be reduced. Namely, the communication burden of the taken picture providing system itself can be reduced.

### Embodiment

A preferred embodiment of the present invention will be described below with reference to the attached drawings.

[Schematic Configuration of Taken Picture Providing System]

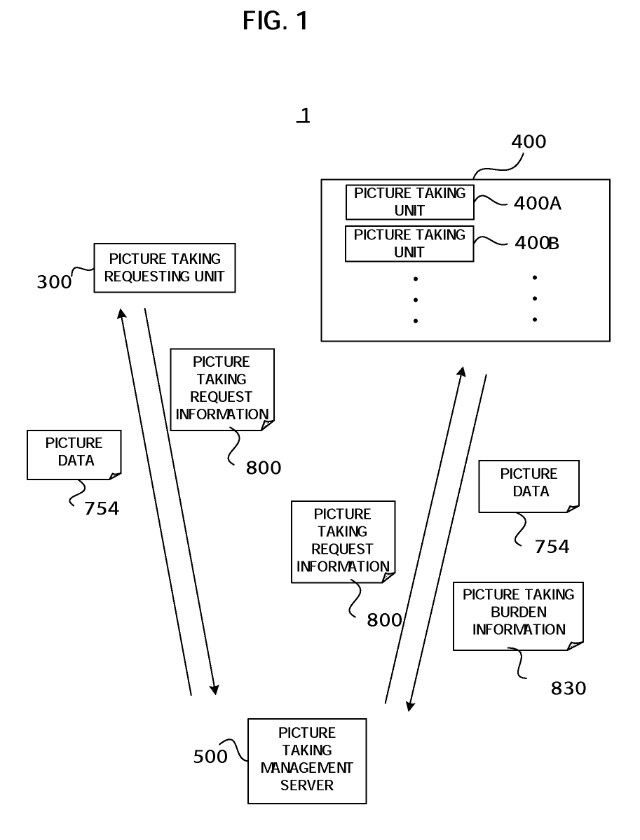

FIG. 1 shows a conceptual diagram of a taken picture providing system. In this embodiment, the taken picture providing system 1 includes a picture taking requesting unit 300, a picture taking unit 400 and a picture taking management server 500. The picture taking requesting unit 300 and the picture taking management server 500 are connected by a predetermined communication means, and the picture taking management server 500 and the picture taking unit 400 are connected by a predetermined communication means. Since a plurality of picture taking units 400 exist, each of the picture taking units are expressed with a suffix, such as 400A and 400B.

The picture taking requesting unit 300 transmits picture taking request information 800 including a picture taking position to the picture taking management server 500, and receives picture data 754, which was requested, from the picture taking management server 500. Here, the picture data 754 means still picture data and/or moving picture data.

When the picture taking management server 500 receives the picture taking request information 800 from the picture taking requesting unit 300, it transmits the picture taking request information 800 to each of the picture taking units 400 and performs a transmission request of picture taking burden information 830. The picture taking burden information 830 is information including burden amount of each picture taking unit 400 in taking picture. The detail of the picture taking burden information 830 will be described later.

When the picture taking unit 400 receives the picture taking request information 800 from the picture taking management server 500, it searches for a route including the picture taking position, calculates the burden amount (described later in detail) associated with the route, generates the picture taking burden information 830 including the burden amount, and transmits the picture taking burden information 830 to the picture taking management server 500.

The picture taking management server 500 performs the picture taking request to a picture taking unit 400, whose burden amount 831 in the picture taking burden information 830 obtained from the picture taking units 400 is smallest.

The picture taking unit 400, which receives the picture taking request, takes pictures, generates the picture data 754 and transmits the picture data 754 to the picture taking management server 500.

The picture taking management server 500 transmits the picture data 754 received from the picture taking unit 400 to the picture taking requesting unit 300. Thus, the picture taking requesting unit 300 can obtain desired picture data.

It is noted that the picture taking unit 400 in this embodiment is substantially realized by the constitutional elements of a navigation apparatus 200 described later.

[Navigation Apparatus]

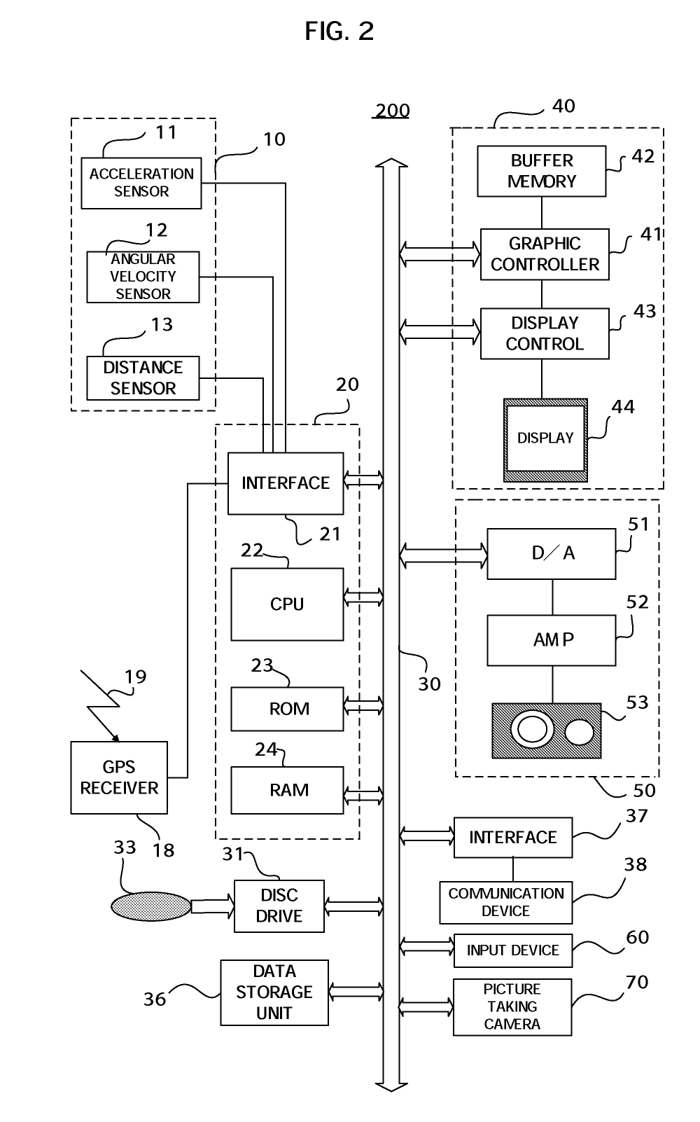

FIG. 2 shows a configuration of a navigation apparatus 200 according to an embodiment of the present invention. As shown in FIG. 2, the navigation apparatus 200 includes a stand-alone position measurement device 10, a GPS receiver 18, a system controller 20, a disc drive 31, a data storage unit 36, a communication interface 37, a communication device 38, a display unit 40, a sound output unit 50, an input device 60 and a picture taking camera 70.

The stand-alone position measurement device 10 includes an acceleration sensor 11, an angular velocity sensor 12 and a distance sensor 13. The acceleration sensor 11 includes a piezoelectric element, for example, and detects the acceleration degree of the vehicle and outputs the acceleration data. The angular velocity sensor 12 includes a vibration gyroscope, for example, and detects the angular velocity of the vehicle at the time of changing the direction of the vehicle and outputs the angular velocity data and the relative direction data. The distance sensor 13 measures vehicle speed pulses including a pulse signal generated with the wheel rotation of the vehicle.

The GPS receiver 18 receives an electric wave 19 for sending downlink data including position measurement data from plural GPS satellites. The position measurement data is used for detecting the absolute position of the vehicle from longitude and latitude information.

The system controller 20 includes an interface 21, a CPU 22, a ROM 23 and a RAM 24, and controls the entire navigation apparatus 200.

The interface 21 executes the interface operation with the acceleration sensor 11, the angular velocity sensor 12, the distance sensor 13 and the GPS receiver 18. Then, the interface 21 inputs the vehicle speed pulse, the acceleration data, the relative direction data, the angular velocity data, the GPS measurement data and the absolute direction data into the system controller 20. The CPU 22 controls the entire system controller 20. The ROM 23 includes a non-volatile memory (not shown) in which a control program for controlling the system controller 20 is stored. The RAM 24 readably stores various kinds of data such as route data preset by the user via the input device 60, and supplies a working area to the CPU 22.

The system controller 20, the disc drive 31 such as a CD-ROM drive or a DVD-ROM drive, the data storage unit 36, the communication interface 37, the display unit 40, the sound output unit 50 and the input device 60 are connected to each other via a bus line 30.

Under the control of the system controller 20, the disc drive 31 reads contents data such as sound data and video data from a disc 33 such as a CD and a DVD to output the contents data. The disc drive 31 may be the CD-ROM drive or the DVD-ROM drive, or may be a drive compatible between the CD and the DVD.

The data storage unit 36 includes HDD, for example, and stores various kinds of data used for a navigation process such as map data and facility data.

The communication device 38 includes an FM tuner, a beacon receiver, a mobile phone and a dedicated communication card, for example, and obtains various kinds of information via the communication interface 37. In this embodiment, the communication device 38 functions as a transmitting/receiving unit.

The display unit 40 displays various kinds of display data on a display device such as a display under the control of the system controller 20. Concretely, the system controller 20 reads the map data from the data storage unit 36. The display unit 40 displays, on a display screen such as a display, the map data read from the data storage unit 36 by the system controller 20. The display unit 40 includes a graphic controller 41 for controlling the entire display unit 40 on the basis of the control data sent from the CPU 22 via the bus line 30, a buffer memory 42 having a memory such as a VRAM (Video RAM) for temporarily storing immediately displayable image information, a display control unit 43 for controlling a display 44 such as a liquid crystal and a CRT (Cathode Ray Tube) on the basis of the image data outputted from the graphic controller 41, and the display 44. The display 44 is formed by a liquid crystal display device of the opposite angle 5-10 inches, and is mounted in the vicinity of a front panel of the vehicle.

The sound output unit 50 includes a D/A converter 51 for executing D/A conversion of the sound digital data sent from the CD-ROM drive 31, a DVD-ROM 32 or the RAM 24 via the bus line 30 under the control of the system controller 20, an amplifier (AMP) 52 for amplifying a sound analog signal outputted from the D/A converter 51, and a speaker 53 for converting the amplified sound analog signal into the sound and outputting it to the vehicle compartment.

The input device 60 includes keys, switches, buttons, a remote controller and a sound input device, which are used for inputting various kinds of commands and data. The input device 60 is arranged in the vicinity of a front panel or the display 44 of a main body of an on-vehicle electric system loaded on the vehicle. Additionally, in such a case that the display 44 is in a touch panel system, a touch panel provided on the display screen of the display 44 functions as the input device 60, too.

The picture taking camera 70 is mounted on the vehicle and takes picture in response to the operation by the user.

(Picture Taking Requesting Unit)

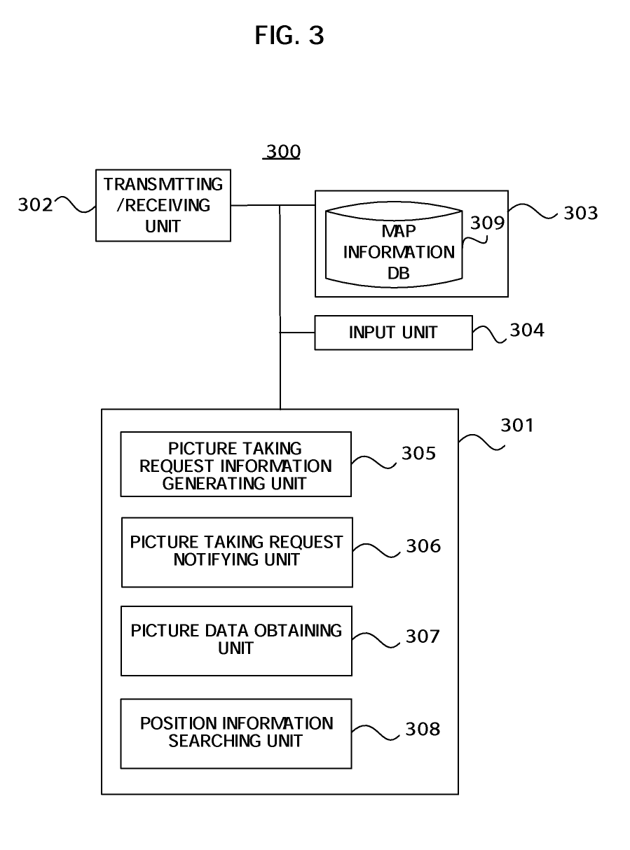

FIG. 3 shows a functional configuration of the picture taking requesting unit 300 for performing the picture taking request. Substantially, the picture taking requesting unit 300 is a personal computer. As shown, the picture taking requesting unit 300 includes a control unit 301, a transmitting/receiving unit 302, a storage unit 303 and an input unit 304. The control unit 301 includes a picture taking request information generating unit 305, a picture taking request notifying unit 306, a picture data obtaining unit 307 and a position information searching unit 308. The control unit 301 is specifically a CPU, which controls the picture taking requesting unit 300 in its entirety. Namely, by the control unit 301 executing a predetermined program, the picture taking request generating unit 305, the picture taking request notifying unit 306, the picture data obtaining unit 307 and the position information searching unit 308 are realized.

The transmitting/receiving unit 302 transmits the picture taking request information 800, and receives the picture data 754.

The storage unit 303 stores various data. Specifically, the storage unit 303 stores the map information DB 309 and the picture data 754 received from the picture taking management server 500.

The input unit 304 is formed by keys, switches, buttons, a remote-controller and a voice input device, for inputting various commands and data.

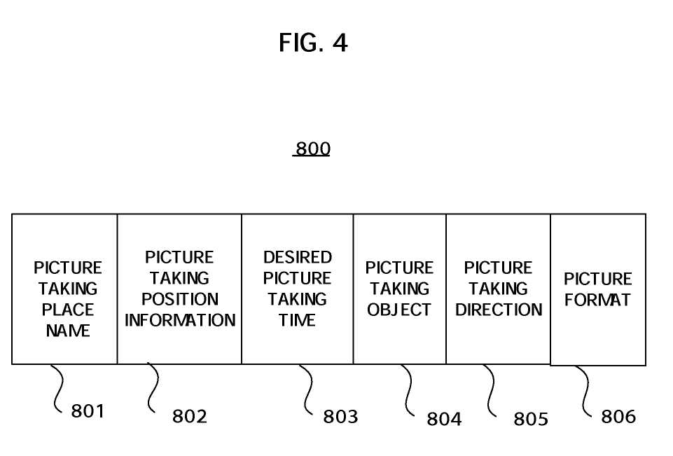

The picture taking request information generating unit 305 generates the picture taking request information 800 in response to the operation by the user. The data structure of the picture taking request information 800 is shown in FIG. 4. The picture taking request information 800 includes a picture taking place name 801, a picture taking position information 802, a desired picture taking time 803, a picture taking object 804, a picture taking direction 805 and picture format 806.

The picture taking place name 801 is a name of a place where the picture taking is desired, and is set by the input operation of the user. The picture taking position information 802 is coordinate values (latitude and longitude) of the picture taking place. To the picture taking position information 802, the search result obtained by the position information searching unit 308 described later searching for the picture taking place name 801 is set. The picture taking position information 802 may be set by the user's input operation. The desired picture taking time 803 is the time at which the picture taking is desired, and is set by the user's input operation. The picture taking object 804 is an object of taking picture at the picture taking place, and is set by the user's input operation. The picture taking direction 805 is a direction to which the picture taking is desired, and is set by the user's input operation. The picture format 806 indicates the format of the taken picture (still picture, moving picture, etc.), and is set by the user's input operation.

The picture taking request notifying unit 306 transmits the picture taking request information 800 generated by the picture taking request information generating unit 305 to the picture taking management server 500 via the transmitting/receiving unit 302, and performs the picture taking request.

The picture data obtaining unit 307 stores the picture data 754 received from the picture taking management server 500 into the storage unit 303.

The position information searching unit 308 searches the map information DB 309, and obtains the coordinate values corresponding to the picture taking place name 801 inputted by the user. The coordinate values are used as the picture taking position information 802. The map information DB 309 is a database storing map information.

(Picture Taking Management Server)

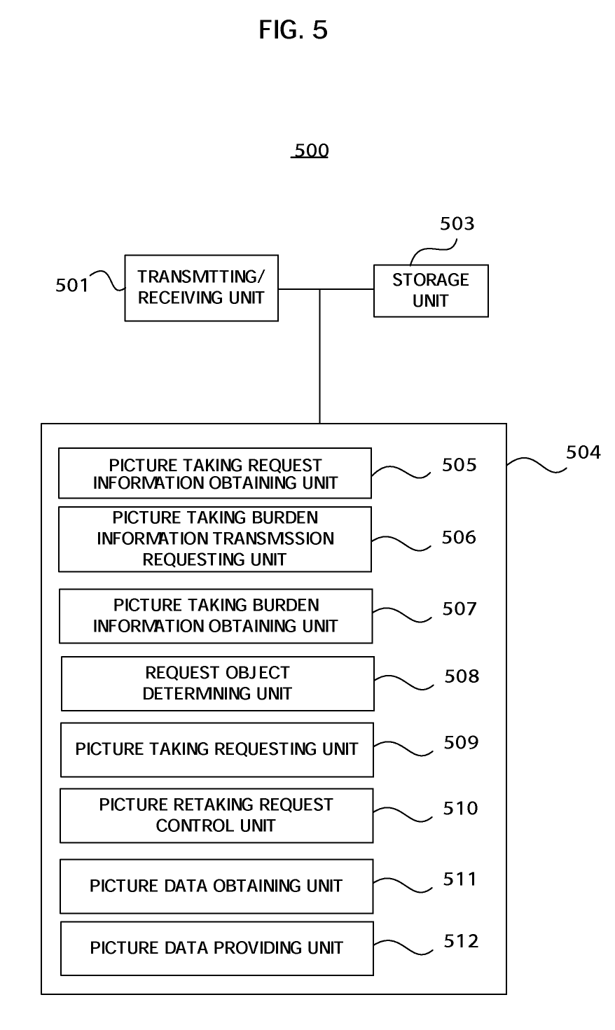

FIG. 5 shows the functional configuration of the picture taking management server 500. The picture taking management server 500 is substantially a server apparatus. As shown, the picture taking management server 500 includes a transmitting/receiving unit 501, a storage unit 503 and a control unit 504. The control unit 504 includes a picture taking request information obtaining unit 505, a picture taking burden information transmission requesting unit 506, a picture taking burden information obtaining unit 507, a request-object determining unit 508, a picture taking requesting unit 509, a picture retaking request control unit 510, a picture data obtaining unit 511 and a picture data providing unit 512.

The transmitting/receiving unit 501 transmits and receives the picture taking request information 800, the picture taking burden information 830 and the picture data 754.

The storage unit 503 stores the picture taking request information 800 received from the picture taking requesting unit 300, and stores the picture taking burden information 830 and the picture data 754 received from the picture taking unit 400. The control unit 504 is specifically a CPU, which controls the picture taking management server 500 in its entirety. Namely, by the control unit 504 executing a predetermined program, the picture taking request information obtaining unit 505, the picture taking burden information transmission requesting unit 506, the picture taking burden information obtaining unit 507, the request-object determining unit 508, a picture taking requesting unit 509, the picture retaking request control unit 510, the picture data obtaining unit 511 and the picture data providing unit 512 are realized.

The picture taking request information obtaining unit 505 receives the picture taking request information 800 via the transmitting/receiving unit 501, and stores the picture taking request information 800 into the storage unit 503.

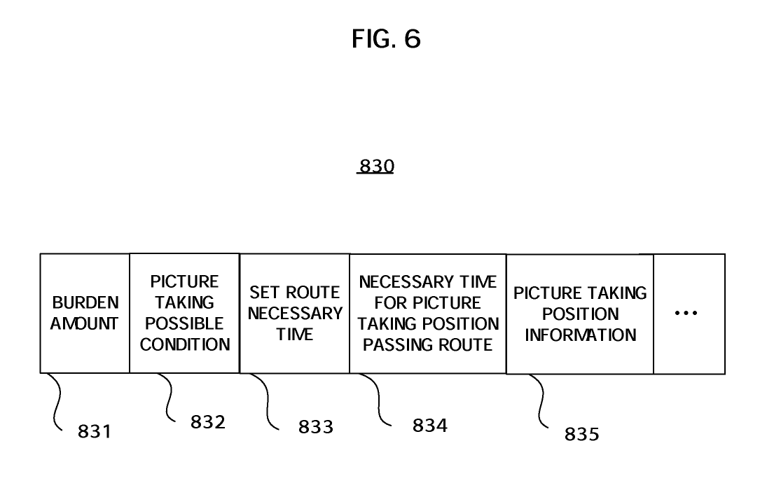

The picture taking burden information transmission requesting unit 506 transmits the picture taking request information 800 received from the picture taking requesting unit 300 to each of the picture taking units 400, and performs the providing request of the picture taking burden information 830. FIG. 6 shows the data structure of the picture taking burden information 830. The picture taking burden information 830 includes a burden amount 831, a picture taking possible condition 832, a set route necessary time 833, a necessary time for picture taking position passing route 834 and a picture taking position information 835.

The burden amount 831 is a burden occurring in taking the picture at the picture taking place according to the picture taking position passing route 705 which passes the picture taking place. Specifically, the burden amount 831 is an increased amount of the necessary time when the travel route is changed from the currently-set route to the picture taking position passing route 705.

The picture taking possible condition 832 is a condition with which the picture taking unit 400 takes the picture. For example, a concrete example of the picture taking possible condition 832 is that “the picture taking is possible, if the increased amount of the necessary time in case that the current route is changed to the picture taking position passing route is equal to or smaller than one hour”. The picture taking possible condition 832 is set based on the input operation of the user of the picture taking unit 400.

The set route necessary time 833 is a necessary time required when the vehicle travels based on the currently set route. The necessary time for picture taking position passing route 834 is a necessary time required when the vehicle travels based on the route including the picture taking position. The picture taking position information 835 indicates the position information (latitude and longitude) of the picture taking place.

The picture taking burden information 830 may include various information such as the current position information of the picture taking unit 400.

The picture taking burden information obtaining unit 507 receives the picture taking burden information 830 from each of the picture taking units 400 via the transmitting/receiving unit 501.

The request-object determining unit 508 determines the picture taking unit 400 to which the picture taking request is performed. Specifically, the request-object determining unit 508 refers to the picture taking burden information 830 that the picture taking burden information obtaining unit 507 obtains from each of the picture taking units 400, and determines the picture taking unit 400, which has transmitted the picture taking burden information 830 having smallest burden amount 831, as the picture taking request object.

If the contents of the picture taking possible condition 832 indicates that the taking picture is impossible, the request-object determining unit 508 eliminates the picture taking unit 400 even if its burden amount 831 is smallest.

The picture taking requesting unit 509 performs the picture taking request to the picture taking unit 400 which the request-object determining unit 508 determines as the picture taking request object. The picture retaking request control unit 510 performs the picture retaking request process when it receives the picture taking canceling request from the picture taking unit 400 which has received the picture taking request. In the picture retaking request process, the picture retaking request control unit 510 transmits the picture taking request information 800 to the picture taking units 400 except for the picture taking unit 400 performed the picture taking canceling request, and performs the providing request of the picture taking burden information 830. Then, the picture retaking request control unit 510 receives the picture taking burden information 830, and performs the picture taking request to the picture taking unit 400 whose burden amount 831 in the picture taking burden information 830 is smallest, from the picture taking units 400 except for the picture taking unit 400 performed the picture taking canceling request.

The picture data obtaining unit 511 obtains the picture data 754 from the picture taking unit 400 to which the picture taking request is performed. The picture data obtaining unit 511 stores the picture data 754 into the storage unit 503. The picture data providing unit 512 transmits the picture data 754 obtained by the picture data obtaining unit 511 to the picture taking requesting unit 300.

(Picture Taking Unit)

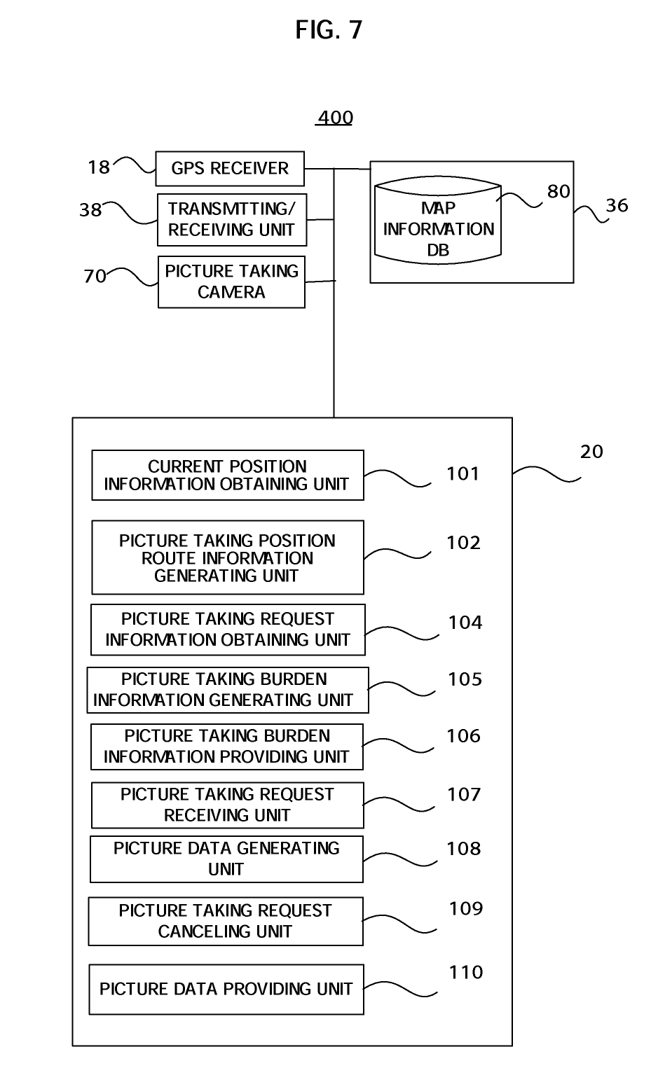

FIG. 7 shows a functional configuration of the picture taking unit 400. The picture taking unit 400 is substantially formed by the constitutional elements of the navigation apparatus 200. As shown, the picture taking unit 400 includes the GPS receiver 18, the system controller 20, the data storage unit 36, a transmitting/receiving unit 38, the picture taking camera 70 and a map information DB 80. The system controller 20 includes a current position information obtaining unit 101, a picture taking position route information generating unit 102, a picture taking request information obtaining unit 104, a picture taking burden information generating unit 105, a picture taking burden information providing unit 106, a picture taking request receiving unit 107, a picture data generating unit 108, a picture taking request canceling unit 109 and a picture data providing unit 110. Namely, by the system controller 20 executing a predetermined program, the current position information obtaining unit 101, the picture taking position route information generating unit 102, the picture taking request information obtaining unit 104, the picture taking burden information generating unit 105, the picture taking burden information providing unit 106, the picture taking request receiving unit 107, the picture data generating unit 108, the picture taking request canceling unit 109 and the picture data providing unit 110 are realized.

The map information DB 80 is a database storing map information. The current position information obtaining unit 101 obtains the latitude and the longitude of the current position from the GPS receiver 18. In this embodiment, the map information DB 80 functions as the map information storing means.

The picture taking position route information generating unit 102 searches the map information DB 80 for the route including the picture taking position, and generates the route information associated with the picture taking position. The route information includes a departure point, a destination, a route, a necessary time and a departure time. Specifically, first the picture taking position route information generating unit 102 determines whether or not the route information associated with the time zone before or after the desired picture taking time 803 of the picture taking request information 800 is set. If there is such a set route, the picture taking position route information generating unit 102 generates the route information associated with the route passing the picture taking position. If there is no such set route, the picture taking position route information generating unit 102 generates route information associated with a route from a predetermined departure point (e.g., current position) to the picture taking position. If the desired picture taking time 803 of the picture taking request information 800 is set, the picture taking position route information generating unit 102 sets the departure time of the route information so that the vehicle can reach the picture taking position by the desired picture taking time 803.

If there is no set route, the picture taking position route information generating unit 102 may request the user to input the place where the user is scheduled to stay at the desired picture taking time 803, thereby to set the position information corresponding to inputted place to the departure point.

The picture taking request information obtaining unit 104 stores the picture taking request information 800 transmitted from the picture taking management server 500 into the data storage unit 36.

The picture taking burden information generating unit 105 generates the picture taking burden information 830 by using the route information generated by the picture taking position route information generating unit 102 or the set route information.

Specifically, if there is a set route corresponding to the desired picture taking time 803, the picture taking burden information generating unit 105 sets the necessary time in the set route information to the set route necessary time 833, and sets the necessary time in the route information generated by the picture taking position route information generating unit 102 to the necessary time for picture taking position passing route 834. Then, the picture taking burden information generating unit 105 sets, to the burden amount 831, the increased amount of the necessary time to the destination if the route is changed from the set route to the picture taking position passing route 705.

If there is no set route corresponding to the desired picture taking time 803, the picture taking burden information generating unit 105 sets “0” to the set route necessary time 833, and sets the necessary time in the route information calculated by the picture taking position route information generating unit 102 to the necessary time for picture taking position passing route 834. Then, the picture taking burden information generating unit 105 sets, to the burden amount 831, the necessary time of round trip from the departure point to the picture taking place.

Regardless that there is a set route information coincides with the desired picture taking time 803, the picture taking burden information generating unit 105 sets the picture taking position information 802 of the picture taking request information 800 to the picture taking position information 835, and sets the picture taking possible condition inputted by the input operation by the user to the picture taking possible condition 832 of the picture taking burden information 830.

The picture taking burden information providing unit 106 provides the picture taking burden information 830 to the picture taking management server 500 via the transmitting/receiving unit 38.

The picture taking request receiving unit 107 sets the route information associated with the route including the picture taking position, after receiving the picture taking request. Thus, the route guide is performed by the route search contents. The picture data generating unit 108 generates the picture data 754 of the object which the picture taking camera 70 takes.

The picture taking request canceling unit 109 performs the picture taking canceling request for the picture taking request already received, to the picture taking management server 500. The picture data providing unit 110 transmits the picture data 754 to the picture taking management server 500 via the transmitting/receiving unit 38.

(Method of Burden Information Calculation and Picture Taking Request)

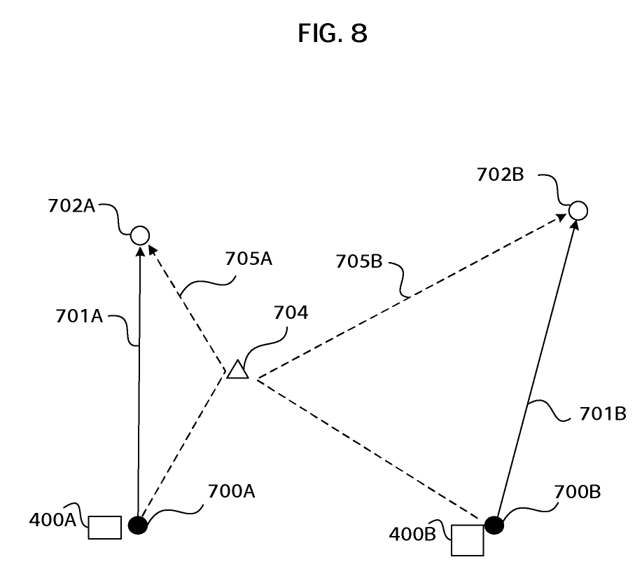

The method of burden information calculating and picture taking request will be described with reference to FIG. 8.

There are a picture taking unit 400A and a picture taking unit 400B. The picture taking unit 400A is scheduled to move from the current position 700A to the destination 702A according to the set route 701A.

The picture taking unit 400B is scheduled to move from the current position 700B to the destination 702B according to the set route 701B.

In this case, if the picture taking management server 500 (not shown) transmits the picture taking request information 800 and performs the request of providing the picture taking burden information 830, the picture taking units 400A and 400B specify the picture taking place 704 from the picture taking position information 802 included in the picture taking request information 800.

Then, the picture taking unit 400A searches the route (hereinafter referred to as “picture taking position passing route 750A”) which goes from the current position 700A to the destination 702A via the picture taking position 704, and generates the route information for the picture taking position passing route 705.

Next, the picture taking unit 400A calculates the burden amount 831 by using the route information for the picture taking position passing route 705A and the route information for the set route 701A. In this embodiment, the burden amount is the increased amount of the necessary time to the destination 702 in a case that the travel route is changed from the set route 701A to the picture taking position passing route 705A.

Similarly, the picture taking unit 400B searches the route (hereinafter referred to as “picture taking position passing route 750B”) which goes from the current position 700B to the destination 702B via the picture taking position 704, and generates the route information for the picture taking position passing route 705.

Next, the picture taking unit 400B calculates the burden amount 831 by using the route information for the picture taking position passing route 705B and the route information for the set route 701B. In this embodiment, the burden amount is the increased amount of the necessary time to the destination 702 in a case that the travel route is changed from the set route 701B to the picture taking position passing route 705B.

As described above, the picture taking units 400A, 400B specify the picture taking place 704 by using the picture taking position information 802 of the picture taking request information 800 received from the picture taking management server 500, calculate the route information for the picture taking position passing routes 705A, 705B passing the picture taking place 704, and thereafter calculates the burden amount 831, respectively, by using the necessary time of the set route 701A, 701B and the necessary time of the picture taking position passing route 705A, 705B.

If there is no set route (route information for the set route 701), the picture taking unit 400 searches the route from the current position 700 to the picture taking position 704, and calculates the necessary time for the round trip from the current position 700 to the picture taking place 704 as the burden amount 831.

Next, when the picture taking management server 500 obtains the picture taking burden information 830 from the picture taking units 400A, 400B, it refers to the burden amounts 831 of the picture taking burden information 830 obtained from each of the picture taking units 400A, 400B, and determines the picture taking unit 400 whose burden amount 831 is smallest as the picture taking unit 400 of the picture taking request object.

In the case of FIG. 8, the increased amount of the travel distance in changing the travel route from the set route 701 to the picture taking position passing route 705 is larger for the picture taking unit 400B than for the picture taking unit 400A. Therefore, the increased amount of the necessary time which is the burden amount is larger for the picture taking unit 400B. Thus, the picture taking management server 500 determines the picture taking unit 400A having smaller burden amount 831 than the picture taking unit 400B, as the picture taking request object.

As described above, the picture taking management server 500 determines the picture taking unit 400 to which picture taking request is performed, based on the burden amount 831 of the picture taking burden information 830 generated by each of the picture taking units 400. By this, the picture taking management server 500 can discriminate the picture taking unit 400 for which the influence by the picture taking is small.

(Picture Taking Requesting Process)

Next, the “picture taking requesting process” according to this embodiment will be described.

In the “picture taking requesting process” according to this embodiment, the picture taking requesting unit 300 transmits the picture taking request information 800 and performs the picture taking request to the picture taking management server 500. Thereafter, when receiving the picture data 754 from the picture taking management server 500, the picture taking requesting unit 300 stores the picture data 754 into the storage unit 303.

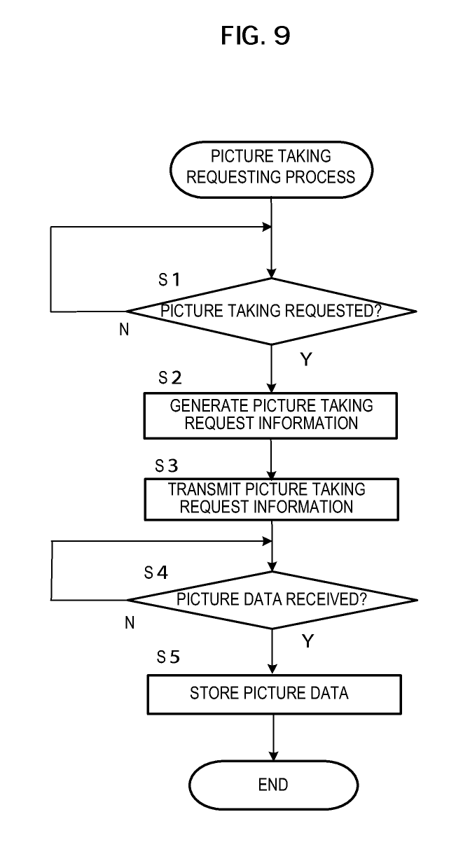

FIG. 9 shows a flowchart of the “picture taking requesting process” according to this embodiment. This process is realized by the control unit 301 in the picture taking requesting unit 300 executing a program prepared in advance.

First, when the control unit 301 detects that the picture taking request is instructed by the input operation of the user (step S1; Yes), the picture taking request information generating unit 305 generates the picture taking request information 800 (step S2).

Then, the picture taking request notifying unit 306 transmits the picture taking request information 800 via the transmitting/receiving unit 302, and performs the picture taking request to the picture taking management server 500 (step S3).

When the transmitting/receiving unit 302 detects the receiving of the picture data 754 from the picture taking management server 500 (step S4; Yes), the picture data obtaining unit 307 stores the picture data 754 into the storage unit 303 (step S5). Then, the “picture taking requesting process” ends.

(Picture Taking Management Process)

Next, the “picture taking management process” according to this embodiment will be described.

In the “picture taking management process” according to this embodiment, after receiving the picture taking request information 800 from the picture taking requesting unit 300, the picture taking management server 500 transmits the picture taking request information 800 and requests the providing of the picture taking burden information 830 to each of the picture taking units 400. Then, the picture taking management server 500 obtains the picture taking burden information 830 from each of the picture taking units 400, determines the picture taking unit 400, to which the picture taking request is performed, based on the picture taking burden information 830, and performs the picture taking request to the picture taking unit 400 thus determined. Further, when receiving the picture data 754 from the picture taking unit 400 to which picture taking is requested, the picture taking management server 500 transmits the picture data 754 to the picture taking requesting unit 300.

If the picture taking management server 500 receives the canceling request from the picture taking unit 400 to which the picture taking request has been performed, the picture taking management server 500 executes the picture retaking requesting process to perform the picture taking request to other picture taking units 400.

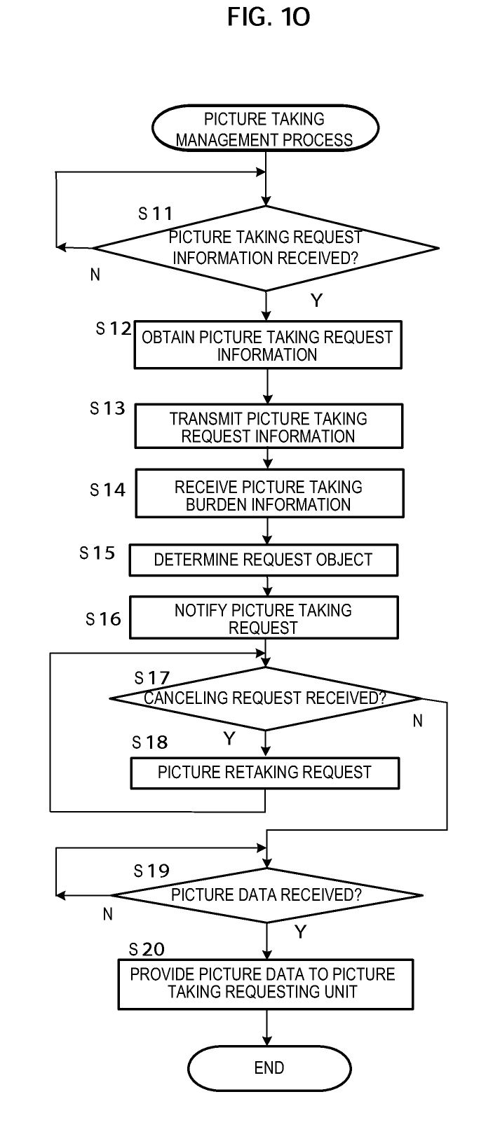

FIG. 10 is a flowchart of the “picture taking management process” according to this embodiment. This process is realized by the control unit 504 in the picture taking management server 500 executing a program prepared in advance.

First, when the transmitting/receiving unit 501 receives the picture taking request information 800 from the picture taking requesting unit 300 (step S11; Yes), the picture taking request information obtaining unit 505 obtains the picture taking request information 800 and stores it into the storage unit 503 (step S12). Then, the picture taking burden information transmission requesting unit 506 transmits the picture taking request information 800 and requests the providing of the picture taking burden information 830 to each of the picture taking units 400 (step S13).

When the picture taking burden information obtaining unit 507 obtains the picture taking burden information from each of the picture taking units 400 (step S14), the request-object determining unit 508 refers to the picture taking burden information 830 to determine the picture taking unit 400 to which the picture taking request is performed (step S15).

Specifically, the request-object determining unit 508 determines the picture taking unit 400, whose burden mount 831 of the picture taking burden information 830 is smallest, as the picture taking request object.

In a case that the taking picture possible condition 832 is set in the picture taking burden information 830, if the burden amount 831 does not coincide with the picture taking possible condition 832, the request-object determining unit 508 eliminates the picture taking unit 400 from the picture taking request object. Thus, the picture taking management server 500 can avoid performing the picture taking request to the picture taking unit 400 which cannot take picture.

Then, the picture taking requesting unit 509 performs the picture taking request to the picture taking unit 400 which the request-object determining unit 508 determines as the picture taking request object (step S16).

Then, when receiving the canceling request from the picture taking unit 400 to which the picture taking request has been performed (step S17; Yes), the picture retaking request control unit 510 performs the picture retaking requesting process (step S18). The picture retaking requesting process is performed as follows: the picture taking request information 800 is transmitted and the providing of the picture taking burden information 830 is requested to the picture taking units 400 other than the picture taking unit 400 which sent the canceling request, the picture taking unit 400 of the picture taking request object is determined based on the picture taking burden information 800 received from each of the picture taking units 400, and the picture taking request is performed to the picture taking unit 400. Actually, steps S13 to S16 are executed. As described above, since the picture retaking request control unit 510 executes the picture retaking requesting process after receiving the canceling request, if the picture taking unit 400 to which the picture taking request has once performed becomes unable to take picture, the picture data 754 desired by the picture taking requesting unit 300 can be obtained from other picture taking unit 400.

When the picture retaking request control unit 510 does not receive the canceling request (step S17; No) and the picture data obtaining unit 511 receives the picture data 754 from the picture taking unit 400 to which the picture taking request has been performed (step S19; Yes), the picture data providing unit 512 transmits the picture data 754 to the picture taking requesting unit 300 (step S20). Then, the control unit 504 ends the picture taking management process.

As described above, the picture taking management server 500 comprises: a picture taking request information obtaining means which obtains picture taking request information from a picture taking requesting apparatus; a picture taking burden information transmission requesting means which transmits the picture taking request information and performs transmission request of picture taking burden information including burden amount to each of picture taking apparatuses; a picture taking burden information obtaining means which obtains the picture taking burden information; a picture taking request object determining means which determines the picture taking apparatus, to which picture taking is requested, based on the picture taking burden information; a picture taking requesting means which requests picture taking to the picture taking apparatus determined by the picture taking request object determining means; a picture data obtaining means which obtains picture data from the picture taking apparatus to which the picture taking is requested by the picture taking requesting means; and a picture data providing means which provides the picture data to the picture taking requesting apparatus.

Therefore, by transmitting the picture taking request information 800 obtained from the picture taking requesting unit 300 to each of the picture taking units 400, the picture taking management server 500 can obtain, from each of the picture taking units 400, the picture taking burden information 830 including the burden amount 831, and can refer to the burden amount 831 to determine the most appropriate picture taking unit 400 for the picture taking. In addition, since the picture taking management server 500 itself does not store the route information of each of the picture taking units 400, it is not necessary for each of the picture taking units 400 to transmit the route change information to the picture taking management server 500 according to the route change of each of the picture taking units 400. Therefore, the communication burden between the picture taking management server 500 and the picture taking units 400 can be reduced.

(Picture Taking Process)

Next, the “picture taking process” will be described.

In the “picture taking process” according to this embodiment, the picture taking unit 400 receives the picture taking request information 800 from the picture taking management server 500 and receives the request of providing the picture taking burden information 830.

Then, the picture taking unit 400 generates the route information for the picture taking position passing route 705, which is a route passing the picture taking position, and calculates the burden amount 831 based on the necessary time for the set route 701 and the necessary time for the picture taking position passing route 705.

Then, the picture taking unit 400 generates the picture taking burden information 830 including the burden amount 831, transmits the picture taking burden information 830 to the picture taking management server 500. When the picture taking management server 500 performs the picture taking request, the picture taking unit 400 sets the route information for the picture taking position passing route 705, and transmits the picture data 754 taken at the picture taking position to the picture taking management server 500.

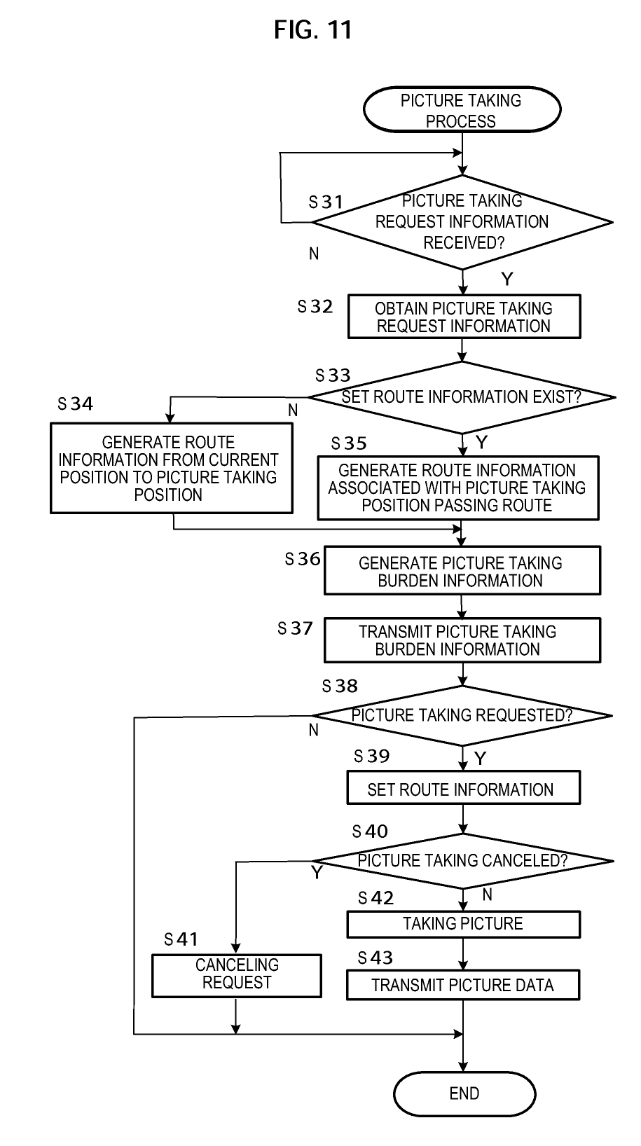

FIG. 11 shows a flowchart of the “picture taking process”. This process is realized by the system controller 20 in the picture taking unit 400 executing a program prepared in advance.

First, when the transmitting/receiving unit 38 receives the picture taking request information 800 transmitted by the picture taking management server 500 (step S31; Yes), the picture taking request information obtaining unit 104 obtains the picture taking request information 800 and stores it into the data storage unit 36 (step S32).

Next, the picture taking position route information generating unit 102 determines whether or not the set route corresponding to the desired picture taking time 803 exits. If the set route information does not exist (step S33; No), the picture taking position route information generating unit 102 searches the route from the current position information obtained by the current information obtaining unit 101 to the picture taking position, and generates the route information for that route (step S34).

If the set route exists (step S33; Yes), the picture taking position route information generating unit 102 searches the route passing the picture taking position between the current position to the destination on the set route 701, and generates the route information for that route (step S35).

Next, the picture taking burden information generating unit 105 generates the picture taking burden information 830 by using the route information that the picture taking position route information generating unit 102 generated (step S36). The picture taking burden information generating unit 105 sets the picture taking possible condition 832 in accordance with the input operation of the user. In this way, since the picture taking unit 400 transmits the picture taking burden information 830 including the picture taking possible condition 832 to the picture taking management server 500 and the picture taking management server 500 refers to the picture taking possible condition 832 to determine the picture taking unit 400 to which the picture taking request is performed, it can be prevented that the picture taking unit 400, having too much burden amount 831 to take picture, receives the picture taking request from the picture taking management server 500.

Next, the picture taking burden information providing unit 106 transmits the picture taking burden information 830 to the picture taking management server 500 (step S37).

Then, the picture taking request receiving unit 107 receives the picture taking request from the picture taking management server 500 (step S38; Yes), it sets the route information for the picture taking position passing route 705 (step S39).

Then, when detecting the picture taking canceling instruction by the input operation of the user (step S40; Yes), the picture taking canceling unit 109 cancels the picture taking to the picture taking management server 500 (step S41). By this, the picture taking unit 400 can cancel the picture taking if the picture taking becomes impossible after receiving the picture taking request from the picture taking management server 500.

If the cancel of the picture taking is not detected (step S40; No), the picture data generating unit 108 takes picture by the picture taking camera 70 to generate the picture data 754 (step S42), and the picture data providing unit 110 transmits the picture data 754 to the picture taking management server 500 (step S43). Then, the system controller 20 ends the process.

As described above, the picture taking unit 400 comprises: a map information storing means which stores map information; a picture taking request information obtaining means which obtains picture taking request information including picture taking position information from a picture taking management server; a picture taking position route information generating means which generates, by using the map information, picture taking position route information which is information associated with a route including the picture taking position, when receiving the picture taking request information; a picture taking burden information generating means which generates picture taking burden information including burden amount associated with the picture taking position route information; a picture taking burden information providing means which provides the picture taking burden information to the picture taking management server; a picture taking request receiving means which receives picture taking request from the picture taking management server; a picture data generating means which generates picture data associated with the picture taking position information; and a picture data providing means which provides the picture data to the picture taking management server.

By this, the picture taking unit 400 receives the picture taking request information 800 including the picture taking position from the picture taking management server 500, searches the picture taking position route including the picture taking position and generates the route information for the picture taking position route. Then, the picture taking unit 400 calculates the burden amount 831 of the picture taking unit 400 by using the necessary time for the picture taking position route, and transmits the picture taking burden information 830 including the burden amount 831 to the picture taking management server 500. Thus, not the picture taking management server 500, but each of the picture taking units 400 calculates the burden amount 831. Therefore, it is not necessary for the picture taking management server 500 to unifiedly store the route information of each of the picture taking units 400, and it is not necessary for the picture taking units 400 to notify the route change to the picture taking management server 500 every time when the route of the picture taking unit 400 is changed. Thus, the communication burden of the picture taking management server 500 and each of the picture taking units 400 can be reduced.

### Other Embodiments

In the above embodiment, the picture taking unit 400 is applied to the car navigation device 200. However, the present invention is not limited to this embodiment. The picture taking unit 400 may be applied to various devices having a GPS receiver and a camera (for example, a cell-phone).

Although the above embodiment does not particularly mentioned, the picture taking management server 500 may give predetermined point to the picture taking unit 400 which actually took the picture.

Although the above embodiment does not particularly mentioned, the performance condition of the picture taking camera 70 may be added to the picture taking request information 800, and the performance information of the picture taking camera may be added to the picture taking burden information 830.

In this case, the picture taking requesting unit 300 sets the performance condition of the picture taking camera 70 to the picture taking request information 800 in accordance with the input operation of the user, and transmits the picture taking request information 800 to the picture taking management server 500. The picture taking unit 400 includes the performance information of the picture taking camera 70 in the picture taking burden information 830 and transmits the picture taking burden information 830 to the picture taking management server 500. Thereby, the picture taking management server 500 can determine the picture taking unit 400, to which the picture taking request is performed, by comparing the performance condition of the picture taking camera 70 and the performance information of the picture taking camera of the picture taking unit 400. Therefore, the picture taking management server 500 can provide the picture data 754 having the picture quality that the picture taking requesting unit 300 itself desires.

The above embodiment is directed to the case where the picture taking possible condition 832 is included in the picture taking burden information 830. However, the present invention is not limited to this embodiment, and the picture taking possible condition 832 may be stored in the picture taking management server 500 in advance.

In the above embodiment, the burden amount 831 is calculated based on the necessary time in a case that the picture is taken at the picture taking position according to the picture taking position passing route 705. However, the present invention is not limited to this embodiment, and the burden amount 831 may be calculated based on the distance of the picture taking position passing route.

### INDUSTRIAL APPLICABILITY

This invention can be used for a taken picture providing system which provides picture corresponding to the picture taking request from an apparatus which is not located at the picture taking place.

1-13. (canceled)

14. A picture taking management server comprising:
a picture taking request information obtaining means which obtains picture taking request information from a picture taking requesting apparatus;
a picture taking burden information transmission requesting means which transmits the picture taking request information and performs transmission request of picture taking burden information including burden amount to each of picture taking apparatuses;
a picture taking burden information obtaining means which obtains the picture taking burden information;
a picture taking request object determining means which determines the picture taking apparatus, to which picture taking is requested, based on the picture taking burden information;
a picture taking requesting means which requests picture taking to the picture taking apparatus determined by the picture taking request object determining means;
a picture data obtaining means which obtains picture data from the picture taking apparatus to which the picture taking is requested by the picture taking requesting means; and
a picture data providing means which provides the picture data to the picture taking requesting apparatus,
wherein the picture taking burden information includes picture taking possible condition information, and
wherein the picture taking request object determining means eliminates the picture taking apparatus which transmitted the picture taking burden information including the burden amount inconsistent with the picture taking possible condition information.

15. The picture taking management server according to claim 14, wherein the burden amount is a difference value between a set route and a route passing the picture taking place.

16. The picture taking management server according to claim 14, further comprising a picture retaking request control means which performs picture retaking request when receiving a picture taking canceling request.

17. A picture taking management method comprising:
a picture taking request information obtaining process which obtains picture taking request information from a picture taking requesting apparatus;
a picture taking burden information transmission requesting process which transmits the picture taking request information and performs transmission request of picture taking burden information including burden amount to each of picture taking apparatuses;
a picture taking burden information obtaining process which obtains the picture taking burden information;
a picture taking request object determining process which determines the picture taking apparatus, to which picture taking is requested, based on the picture taking burden information;
a picture taking requesting process which requests picture taking to the picture taking apparatus determined by the picture taking request object determining process;
a picture data obtaining process which obtains picture data from the picture taking apparatus to which the picture taking is requested by the picture taking requesting process; and
a picture data providing process which provides the picture data to the picture taking requesting apparatus, wherein the picture taking burden information includes picture taking possible condition information, and wherein the picture taking request object determining process eliminates the picture taking apparatus which transmitted the picture taking burden information including the burden amount inconsistent with the picture taking possible condition information.

18. A picture taking management program embodied in a computer-readable medium and executed by an apparatus including a computer, the program makes the computer function as:
a picture taking request information obtaining means which obtains picture taking request information from a picture taking requesting apparatus;
a picture taking burden information transmission requesting means which transmits the picture taking request information and performs transmission request of picture taking burden information including burden amount to each of picture taking apparatuses;
a picture taking burden information obtaining means which obtains the picture taking burden information;
a picture taking request object determining means which determines the picture taking apparatus, to which picture taking is requested, based on the picture taking burden information;
a picture taking requesting unit which requests picture taking to the picture taking apparatus determined by the picture taking request object determining means;
a picture data obtaining unit which obtains picture data from the picture taking apparatus to which the picture taking is requested by the picture taking requesting means; and
a picture data providing means which provides the picture data to the picture taking requesting apparatus,
wherein the picture taking burden information includes picture taking possible condition information, and
wherein the picture taking request object determining means eliminates the picture taking apparatus which transmitted the picture taking burden information including the burden amount inconsistent with the picture taking possible condition information.

19. A picture taking apparatus comprising:
a map information storing means which stores map information;
a picture taking request information obtaining means which obtains picture taking request information including picture taking position information from a picture taking management server;
a picture taking position route information generating means which generates, by using the map information, picture taking position route information which is information associated with a route including the picture taking position, when receiving the picture taking request information;
a picture taking burden information generating means which generates picture taking burden information including burden amount associated with the picture taking position route information;
a picture taking burden information providing means which provides the picture taking burden information to the picture taking management server;
a picture taking request receiving means which receives picture taking request from the picture taking management server;
a picture data generating means which generates picture data associated with the picture taking position information; and
a picture data providing means which provides the picture data to the picture taking management server,
wherein the picture taking burden information includes picture taking possible condition information.

20. The picture taking apparatus according to claim 19, wherein the burden amount is a difference value between a set route and a route passing the picture taking place.

21. The picture taking apparatus according to claim 19, further comprising a picture taking request canceling means which cancels the picture taking request received by the picture taking request receiving means.

22. A picture taking method comprising:
a map information storing process which stores map information;
a picture taking request information obtaining process which obtains picture taking request information including picture taking position information from a picture taking management server;
a picture taking position route information generating process which generates, by using the map information, picture taking position route information which is information associated with a route including the picture taking position, when receiving the picture taking request information;
a picture taking burden information generating process which generates picture taking burden information including burden amount associated with the picture taking position route information;
a picture taking burden information providing process which provides the picture taking burden information to the picture taking management server;
a picture taking request receiving process which receives picture taking request from the picture taking management server;
a picture data generating process which generates picture data associated with the picture taking position information; and
a picture data providing process which provides the picture data to the picture taking management server,
wherein the picture taking burden information includes picture taking possible condition information.

23. A picture taking program embodied in a computer-readable medium and executed by an apparatus including a computer, the program makes the computer function as:
a map information storing means which stores map information;
a picture taking request information obtaining means which obtains picture taking request information including picture taking position information from a picture taking management server;
a picture taking position route information generating means which generates, by using the map information, picture taking position route information which is information associated with a route including the picture taking position, when receiving the picture taking request information;
a picture taking burden information generating means which generates picture taking burden information including burden amount associated with the picture taking position route information;
a picture taking burden information providing means which provides the picture taking burden information to the picture taking management server;
a picture taking request receiving means which receives picture taking request from the picture taking management server;
a picture data generating means which generates picture data associated with the picture taking position information; and
a picture data providing means which provides the picture data to the picture taking management server,
wherein the picture taking burden information includes picture taking possible condition information.

24. A taken picture providing system comprising a picture taking requesting apparatus, picture taking apparatuses and a picture taking management server,
wherein the picture taking requesting apparatus comprises:
a picture taking request information generating means which generates picture taking request information including a picture taking position;
a picture taking request notifying means which transmits the picture taking request information and notifies picture taking request to the picture taking management server; and
a picture data obtaining means which obtains picture data from the picture taking management server,
wherein the picture taking management server comprises: a picture taking request information obtaining means which obtains picture taking request information from the picture taking requesting apparatus;
a picture taking burden information transmission requesting means which transmits the picture taking request information and performs transmission request of picture taking burden information including burden amount to each of the picture taking apparatuses;
a picture taking burden information obtaining means which obtains the picture taking burden information;
a picture taking request object determining means which determines the picture taking apparatus, to which picture taking is requested, based on the picture taking burden information;
a picture taking requesting means which requests picture taking to the picture taking apparatus determined by the picture taking request object determining means;
a picture data obtaining means which obtains the picture data from the picture taking apparatus to which the picture taking is requested by the picture taking requesting means; and
a picture data providing means which provides the picture data to the picture taking requesting apparatus,
wherein the picture taking burden information includes picture taking possible condition information, and
wherein the picture taking request object determining means eliminates the picture taking apparatus which transmitted the picture taking burden information including the burden amount inconsistent with the picture taking possible condition information, and wherein the picture taking apparatus comprises:
a map information storing means which stores map information;
a picture taking request information obtaining means which obtains picture taking request information including picture taking position information from the picture taking management server;
a picture taking position route information generating means which generates, by using the map information, picture taking position route information which is information associated with a route including the picture taking position, when receiving the picture taking request information;
a picture taking burden information generating means which generates picture taking burden information including burden amount associated with the picture taking position route information;
a picture taking burden information providing means which provides the picture taking burden information to the picture taking management server;
a picture taking request receiving means which receives picture taking request from the picture taking management server;
a picture data generating means which generates picture data associated with the picture taking position information; and
a picture data providing means which provides the picture data to the picture taking management server.
